(19) United States
(12) Patent Application Publication
(10) Pub. No.: US 2010/0182148 A1
(43) Pub. Date: Jul. 22, 2010

(54) METHOD AND DEVICES FOR TRACKING AND MONITORING CONTAINERS IN GLOBAL TRANSPORTATION

(75) Inventor: Bao Qi Fan, (US)

Correspondence Address: LAW OFFICES OF DONALD COX, P.O. BOX 505, PRINCETON, NJ, 08542-0505, US

(73) Assignee: Shanghai International Port (Group)., Ltd.

(21) Appl. No.: 12/359,274

(22) Filed: Jan. 23, 2009

(30) Foreign Application Priority Data
Jan. 21, 2009 (CN) 200810203616.3

(51) Int. Cl. H04Q 5/22; G08B 13/14

(52) U.S. Cl. 340/572.1; 340/10.51

(57) ABSTRACT

A method for tracking and managing containers in a global supply chain based on a network includes steps of providing a container with an electronic device, inputting basic information of said container into said electronic device and performing encryption at a departure point; detecting automatically status of said container during the transportation to generate a status message responsive to the detected status, record into said electronic device in real time and upload immediately to a management center; recording events information into said electronic device when the container passing through the inspection stations and upload to the management center immediately; and finally decrypting and extracting information of said electronic device at a destination point. An authorized subscriber may retrieve and modify basic information of a container at any time through a terminal. The invention also relates a reader and an electronic device for managing and tracking containers in the global supply chain.

### BACKGROUND OF THE INVENTION

1. Field of the Invention

The present invention relates to a technology for tracking and monitoring containers in global transportation, particularly to a method for tracking and monitoring containers transported in a global supply chain based on a network system and an electronic device and a reader for performing said method.

2. Description of the Related Art

The management for cargo transportation in a global supply chain becomes more and more important along with the increasing of global trade. A global supply chain is a network of international suppliers, manufacturers, distributors, delivers, retailers or supermarkets etc. which handle various goods from most elementary components to any final products and consumer outlets for consumption.

The globalization of logistic system is very helpful to ensure the reliability of the operation of the whole supply chain, whilst the transportation of the container is critical in that it usually covers a broad range across nations and/or continents. For instance, take the shipping of the container as one example, due to the long distance and duration for the shipment, how to track and monitor containers and cargo throughout the whole process of the transportation in real time becomes a main object for the globalized logistic management.

Normally, in a common existing management system an inspector in each checkpoint of the supply chain will manually upload to a control center information for a container, which includes arriving time and departure time together with the inspection result when a container passes through the checkpoint. U.S. Pat. No. 7,129,837 entitled “Continuous Security State Tracking for Containers Transported Through a Global Supply Chain” by David L Shannon, et al., disclosed a method for tracking cargo, and more specially to continuously monitoring the security state for the cargo as it is transported through points in a global supply chain. According to the patent, a control center continuously tracks the security state for the container through a network of multiple checkpoints spanning from a departure point to a destination point, each checkpoint being provided with a site manager in communication with the control center and RFID readers in communication with RFID tags of the containers. The information of the cargo is firstly written with a RFID reader into an electronic device, i.e. a RFID tag arranged on the container and uploaded to the control center before initiating monitor of the security status of the electronic devices of the container. Security information is generated responsive to signals detected by sensors of the electronic device, and read by the readers of the checkpoints and then uploaded by the readers to the control center, which determines and modifies the security status of the goods and the containers based on the information inspected by each checkpoint. In such a way, the above described method continuously tracks the security status for cargo throughout the whole global transportation.

However, the aforesaid continuous tracking for the container is not a real continuous tracking of cargo as it has only limited visibility in the whole global supply chain, which means blind spots exist for those areas between two checkpoints having no information being updated at the control center for a long term.

In order to overcome the drawbacks of the prior art as described above, an international patent application PCT/US2004/014192 entitled “State Monitoring of a Container” by Stephen Lambright et al., disclosed a method for locally determining the status of the containers through state devices. However, the invention of this application fails to provide a solution for determining the status of the container in real time and timely receiving updated latest information of the containers by a monitor of the container, that means the immediately changed information are still not uploaded to the control center in real time, which means the important information, probably the security alert may be delayed and thus lead to inevasible damages.

Moreover, during the whole transportation process for the cargo, the monitor including consignors, consignees, customs, and any other authorized entities may need more complete information for comprehensive evaluation.

Therefore, it is really desirable to introduce an improved method and devices for tracking and monitoring containers in the global supply chain to accomplish real time monitoring of containers and goods throughout the whole transportation.

### SUMMARY OF THE INVENTION

One main object of the invention is to provide a method for tracking and monitoring containers in a global supply chain to accomplish real time monitoring of containers and goods through the whole transportation of the containers.

In order to achieve the above object, the present invention provides a method for tracking and monitoring containers transported in a global supply chain based on a network, which comprises a management center consisting of at least one server, multiple terminals accessible to said network through the Internet, and multiple readers in communication connection with associated terminals, said method comprising steps of providing a container to be monitored with an electronic device configured with a unique identifier number; inputting basic information of said container into said electronic device and performing encryption through a reader at a departure point; detecting automatically status of said container by said electronic device during the transportation to generate status messages responsive to the status detected and record into said electronic device in real time; recording events information into said electronic device by readers of any inspection stations when said electronic device passing there through; decrypting and extracting information of said electronic device by a reader at a destination point; uploading immediately in real time any status message newly generated from said electronic device and event information recorded in said electronic device to the management center through associated readers and terminals in the whole process of monitoring; and retrieving and modifying basic information of a designated container by a subscriber authorized to access said network at any time through a terminal so as to track and monitor said designated container in real time during the whole transportation.

Therefore, since the information detected by the electronic devices is synchronized with the information database in the management center in real time, the authorized subscribers can retrieve the updated basic information, status and event information of the containers to be monitored through any one terminal so as to monitor the real time condition of the containers and accomplish real time track and monitoring continuously.

Another aspect of the present invention is to provide an electronic device for tracking and monitoring containers transported in a global supply chain according to the inventive method. Said electronic device comprises a main control unit, various kinds of sensors, a memory, a radio frequency transceiver, and a power supply device, wherein said main control unit includes a status message generator, which is configured to immediately transmit a newly generated status message through the radio frequency transceiver responsive to a status detected, so as to allow uploading the current status of the electronic device to the management center through the associated readers and terminals in real time; and an information management module, which is configured to modify the basic information of the container according to instructions made by a subscriber authorized to access said network.

A further aspect of the invention is to provide a reader for tracking and monitoring containers transported in a global supply chain according to the inventive method. Said reader comprises a main control unit, a memory, a radio frequency transceiver, an interface in communication connection with associated terminals, and a power supply device, wherein said main control unit includes a communication control module, which is configured to process a status message received from an electronic device and immediately upload the processed status message through the associated terminal to the management center; and send instructions for modifying the basic information of a designated container made by a subscriber authorized to access said network to a corresponding electronic device of said designated container immediately.

Advantageously, the electronic device for tracking and monitoring the containers in the global supply chain based on the network store the basic information of the containers in the memory of said electronic devices provided on the container in a real time base and synchronously upload data to the management center through the terminals. During the whole transportation, the electronic device automatically detects the real time status of the container, generates status messages responsive to the detected signals and records them into the memory, and synchronously uploads the information of the electronic device including immediately generated status messages and recorded event information to the management center through the associated readers and terminals, so as to make the information recorded in the electronic device being synchronized with the data stored in the management center in real time. Furthermore, the latest updated information of real time condition of the containers is retrievable at any time through any one of terminals by a subscriber authorized to access that network. The global network including said electronic devices, readers and terminals distributed over the global supply chain enables all authorized subscribers, such as consignors, consignees, customs, security stations, inspection and quarantine of the board and various agencies/entities to access the network to track and monitor the latest information, such as the container information, the cargo information, transportation information and security information etc.

These and other advantages of the invention will be apparent to those of the skilled in the art by reference to the following detailed description with the accompanying drawings.

### BRIEF DESCRIPTION OF THE FIGURES

FIG. 1 is a block diagram illustrating a principle structure of a network system for tracking and monitoring containers in global transportation according to the present invention;

FIG. 2 is a structural diagram of a simplified network for tracking and monitoring containers in global transportation according to the present invention;

FIG. 3 is a schematic flow chart for the network system in a station-to-station transportation mode according to the present invention;

FIG. 4 is a schematic flow chart for the network system in a port-to-port transportation mode according to the present invention;

FIG. 5 is a structural diagram for an electronic device according to one embodiment of the present invention for performing tracking and monitoring of the containers in the global supply chain; and

FIG. 6 is a structural diagram for a reader according to one embodiment of the present invention for performing tracking and monitoring of the containers in the global supply chain.

### DETAILED DESCRIPTION OF THE PREFERRED EMBODIMENTS

Embodiments of the invention will be described with reference to the accompanying drawings for the purpose of illustration only and not as a limitation to the present invention.

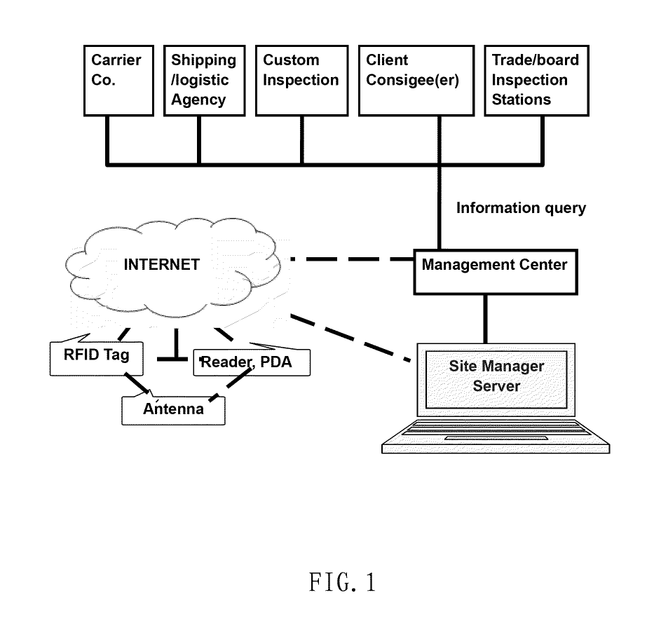

As shown in FIG. 1, a network system for tracking and monitoring containers in a global supply chain according to the present invention generally comprises a service center or a management center for storing information data and performing applications for analysis of the information, electronic devices, readers, site manager severs located at different places, such as export/import ports, any computerized terminals provided in customs or stations for inspection and quarantine of the board or security checkpoints or inspection stations for import/export trade, and other computerized terminals of authorized entities in the network, for example, terminals for clients, i.e. the consignors or consignees, shipping and logistic agencies, carrier companies etc.

Each container to be monitored is provided with an electronic device or in some cases a RFID tag at an appropriate position of the container. Usually, a consignor will encrypt the electronic device when locking the container at an origin point and a consignee will decrypt it when unlocking the container received at a destination point. The electronic device transmits RF signals to RFID readers through its RF transceiver and antenna. The reader receives the RF signals from or transmits it to the electronic device through its RF transceiver and antenna to read or write data on the electronic device.

The readers may be arranged in any transportation vehicles, such as container trucks, carriers or airplanes, as well as various spots, such as ports, customs, stations for inspection and quarantine of the board and inspection stations for import/export trade, etc. The reader may be either dedicated immobile device connecting with a fixed terminal such as a PC through wired or wireless communication, or dedicated mobile device connecting with a mobile terminal such as a PDA through wired or wireless communication. An exemplary handheld device according to the invention integrates a reader, a GPS transceiver and an interface for internet access in one device. The immobile readers are usually installed at permanent buildings of relatively fixed spots such as entry/exit of the ports, quayside/yard gantry crane etc. The mobile readers are usually used for input or read information prior to seal or open the container with the electronic device, and for verifying information or exchange data in inspection of the container. The operation mode of the reader is normally configured in a passive mode that means the reader is normally operating in its receiving mode being ready to receive the signals from the electronic device in real time, and forward the information received from the electronic device to the management center through the associated terminal. Detailed structure and features of specific embodiments of the electronic devices and readers according to the present invention will be described later in following paragraphs.

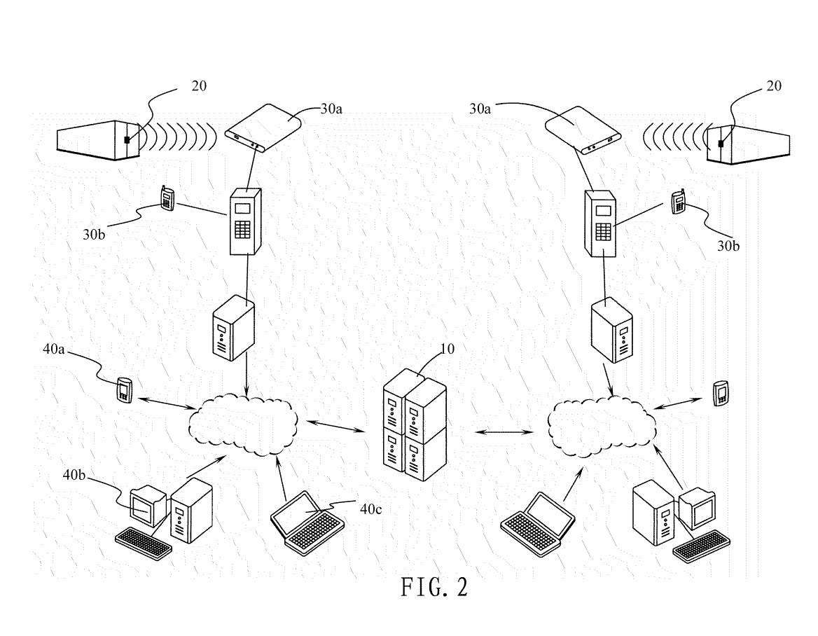

FIG. 2 is the structural diagram of a simplified network for tracking and monitoring container transported based on a network of container logistic RFID devices according to the invention, wherein a management center 10 is composed of at least one server, which can be located together or distributed in different places far away from each other, that means these severs can be distributed across different continents, regions and countries. These servers may include application servers, management servers and data servers etc. for the network system of tracking and monitoring containers. Specially, the information for each globally distributed data server is operatively synchronized in real time. Further, each container to be monitored is provided an electronic device 20 in communication with associated readers 30a, 30b through their RF transceiver. The reader 30a or 30b in turn communicates with the management center 10 through various access networks via terminals. The access network includes but not limited to mobile access network, ADSL access network, HFC wired access network etc. Moreover, an authorized subscribers can access to an operation platform of the management center of the network system through the Internet from any kinds of terminal devices, such as PDA 40a, PC 40b, notebook PC 40c etc. to retrieve or modify information of the electronic device of the container.

The electronic device 20 generally comprises sensors arranged at any required position of a container, a radio frequency transceiver in communication with readers, a modulation/demodulation module, a memory for storing applications and data and a main control unit for running applications, wherein the sensors may includes mechanical sensors, vibration sensors, shock sensors, thermometers, humidity sensors, chemical sensors, optical sensors, biological sensors and radiation sensors etc. to detect physical status of internal/external condition of the container. It can be appreciated that various sensors may be set at different positions of the container. For example, the mechanical sensor may be a moving bolt or a slidable or rotatable shaft of an electronic lock for detecting the lock/unlock or moving status of the door or other components of the container. The shock sensor is to detect whether the container is shocked over a predetermined threshold. The vibration sensor may be set at any positions of the container that are more sensitive towards vibration, so as to effectively detect unexpected vibration caused by any possible intrusion towards the container. Preferably, a backup electronic device configured in synchronization with the first one is also provided for the same container at an inconspicuous place in order to deal with a possible damage or failure of the first electronic device.

The reader 30 may be an immobile device 30a fixedly located on permanent buildings, or moving vehicles such as container trucks, container unit trains, carriers, or quayside/yard gantry container cranes in wired or wireless communication with a site management server in a LAN, or a mobile device 30b with an embedded communication module for Internet access, e.g. a handhold reader. According to the present invention, the reader comprises a RF transceiver, a memory for storing applications and data and a main control unit for running applications. In some embodiments of the invention, the reader may include a data I/O interface in connection with a network terminal. In some other embodiments of the invention, the reader, for example, the handhold reader may further include an IP interface for Internet access.

According to one embodiment of the invention, a GPS module can be provided in the electronic device for receiving/transmitting GPS signals to determine the location of the electronic device by using the GPS positioning technology. According to another embodiment of the invention, a GPS module can be provided separately from and be in connection with the electronic device, for example, to be located on a container truck, a container unit train, a container carrier and other vehicles, or to be provided in the reader. Thus, the geological location of said device, i.e. the electronic device, the various vehicles or the reader, where the GPS module is provided, is determined by said GPS module in those devices.

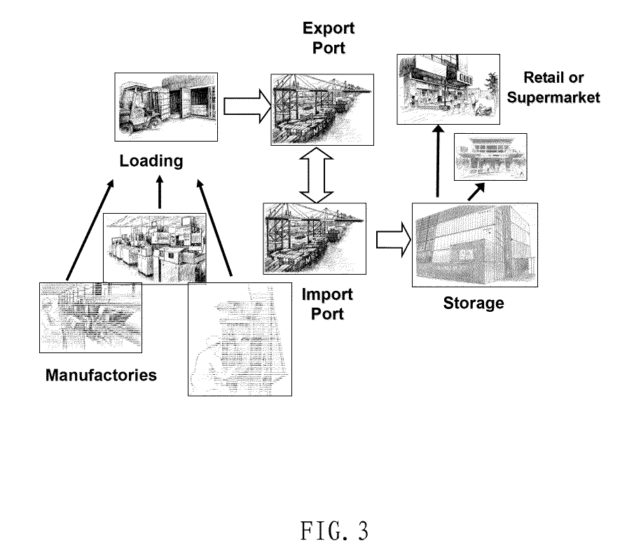

FIG. 3 is a schematic flow chart showing the method for tracking and monitoring containers in a station-to-station transportation mode. Normally, a container provided with the electronic device will enter into monitoring by the network system for tracking and monitoring containers transported in the global supply chain once the container are loaded with contents and locked with an electronic lock or the electronic device. As shown in FIG. 3, the content of the container being tracked undergoes processing of raw materials, assembling from components to packaging of end products, starting from the shipper site after loading the container, it is under monitoring of the system through out the whole transportation route including the road, the railway, the origin port, the seaway, the trans-shipment port, the destination port, the yard for storing the container designated by the consignee, and finally the retail stores or supermarket, for example. During the transportation, the containers may pass by various checkpoints, e.g. customs, stations for inspection and quarantine of the board, stations for trade inspection etc. till all the goods arrives at the consignees or the retail stores.

According to the invention, the monitoring for the container is normally initiated by the supplier or consignor after the container is loaded and locked at the origin site. An electronic device is provided on the container and initialized by a handhold reader or a reader head connected with a computerized terminal device. The initialization processes comprises steps of inputting basic information of the cargo or the content for the container into the electronic device, and encrypting the electronic device by setting up a password for unlocking the container before start tracking the security status of the container. During the transportation, the electronic device generates status messages responsive to the signal detected by the sensors, and once a new status message occurs, the electronic device will record the new status message in the memory and upload it immediately to the management center through associated readers and terminals. When the container pass through the checkpoints of any stations, the electronic device entered into a working range of a reader in each station will return information in response to the RF signal sent from the reader through its antenna to activate communication between the electronic device and the reader, thereby the electronic device is scanned and read by the reader. The reader automatically identifies the electronic device and retrieves information of the container by scanning the electronic devices, stores the retrieved information into the memory of the reader. The reader also records data for event information into a corresponding electronic device of a designated container upon the inspection of said container. Both the retrieved and recorded data are immediately uploaded to the management center in either manual or automatic mode. This uploading can also be performed through the terminal connected with the reader according to instructions received from an authorized subscriber. Having undergone the transportation of seaway and land road, the container arrived at the destination will also pass several stations including management checkpoints of the port, custom, security or trade inspection stations etc., and then transferred from the destination port to a container storage place close to the consignee through a land road. During the transportation on the seaway, immobile readers fixedly provided on the carrier are used to scan all the containers loaded thereon to detect the location of the containers and receive information from the containers once a status message is generated by the electronic device of the container. All relevant information is immediately transmitted to the reader and uploaded through the reader and the associated terminal in real time to the management center, since the electronic devices are activated to transmit data in response to the generation of the status message. After all, the consignee finally receives the good of the container by input the previously set password through a reader at the destination, so as to decrypt and unlock the container, checks all goods in the container and all information stored in the electronic device, and compare with the data stored in the management center.

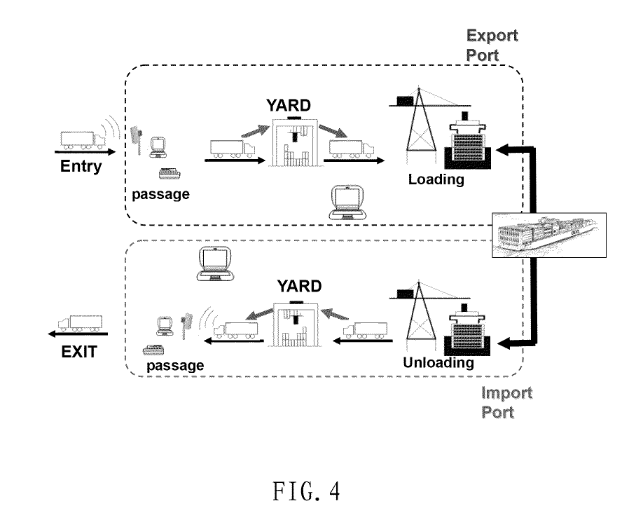

FIG. 4 is a schematic flow chart showing the method for tracking and monitoring containers in a port-to-port transportation mode. As shown in FIG. 4, when a container truck enters into a quayside of a departure port, the electronic device of the container is scanned by the reader provided on a passage of each entrance. The information stored in the electronic devices will be read by the reader, and a new event information of the inspection probably including a legal pass report for the container passing through a checkpoint will also be recorded into the electronic device. Meanwhile, the inspection information will be transferred to the site management server in the port through the communication terminal of the reader, and finally uploaded to the management center. Next, when the container is moved to the container yard from the container trucks at an appropriate position, the immobile readers around the container yard, and container cranes and the gantry cranes will scan the electronic device, and updating and recording information in the electronic device. Any changes of information of the containers will also be scanned, updated and recorded immediately by the readers, and then uploaded to the management center by those immobile readers during the transferring of the containers from one place to another, e.g. from the yard to the on board shipside through the communication terminal associated with the corresponding reader. In the transportation period on the sea, the immobile readers on the container carrier will scan and detect the location information and status of the containers, then the relevant information will be recorded in the electronic device and uploaded to the management center. Once a status message is generated, the communication mode of the electronic device is activated, and the data of the information will be initiatively transmitted to the reader by the electronic device. In turn, the information of the location and the status of the container will be immediately uploaded to the management center in real time. During the transportation on the sea, it is possible that some part of goods may be transferred to another destination via a designated trans-shipment port, all the information including opening/closing and unlocking/locking of the container, some particular operations, any changes of location of the container, and changes of status will be immediately updated and recorded in the electronic devices in real time, and in the meanwhile some events like the inspection information will be input into the electronic device and also uploaded to the management center through an associated terminal. When the container arrives at a destination site or a destination port, the afore-described processes will be performed in a reverse order, therefore all changes and status of the container through out the whole transportation route are under the monitoring of the system in real time.

Overall, the container provided with the electronic device passing through all checkpoints along a whole global supply chain will be scanned by various readers continuously distributed and located at different positions and all checkpoints. The information stored in the electronic device of the containers will be identified and verified in comparison with the information stored in the management center. While the event information for the inspection will be recorded in the electronic device and immediately uploaded to the management center, and thereby synchronize the data in the management center with that in the electronic device.

It should be noted that, besides the information stored in the electronic device is scanned and updated by the reader when the containers pass through each checkpoint in the global supply chain, any new status messages generated wherever by the electronic device during the whole transportation is also recorded in a local storage unit in the electronic device and simultaneously sent to the site management server by the associated reader and terminal, and then the newly generated status message is uploaded to the management center through the Internet. Those readers include the readers fixed on the vehicles, such as container trucks, container unit trains and carries, which constitutes a continuously distributed readers network through out the whole transportation.

Therefore, the method for tracking and monitoring the container transported in a global supply chain based on the network system in accordance with the present invention allows a real time continuous tracking and monitoring of the container during the whole transportation, the latest information at any time and any locations will be recorded in the electronic device and immediately uploaded to the management center through the readers in real time. As a result, the information in the electronic device is synchronized with the information in the management center in real time. The electronic device will generate a status message responsive to a signal produced by a sensor each time when the sensor detects a status change of the container based on predefined logic and rules. The new status messages will be recorded in a storage unit of the electronic device, and meanwhile initiatively transmitted to the associated reader. Then, the reader reads the new status message from the electronic device. Alternatively, in addition to the uploading of the new status, the status can also be presented by indicators provided on the electronic devices, for example, LED or LCD display, or sound speaker etc.

Usually the monitoring of the electronic device is initialized before the containers depart from the origin where the consignor loads the container with goods. An operator must input relevant basic information of the container and the goods into the electronic device, and set up privilege password and/or security password etc. upon closing of the containers and locking of the electronic lock. Said basic information includes, but not limited to, cargo information, container information, logistics information, initialized security information and other required information. Wherein, the cargo information comprises bill number, name and type of the cargo, weight of the cargo, rank of hazard, sub-package number, and/or sub-volume etc., and the container information includes information required by standardized IMC, IBC and RTC etc. The logistics information includes information for vehicles including container truck, unit train, carrier and/or airplane, operation information, information of import/export or trans-shipment port, and/or agencies. The initialized security information includes locking position, time, location, and/or physical status for a container at the locking time, the privilege or security password, etc.

Various physical status of the container detected by the sensors of the electronic device will be processed by the main control unit to locally determine a current status, or alternatively, be processed by pre-installed applications in the management center to determine a current status. The determined status of the container may be suitably presented by an indication mean of the electronic devices, in addition to or as well as transmitted to an entity and/or individual as a subscriber of this network through the network terminal. The container security status as defined according rules include, for example, unauthorized opening, instruction or breaking the container, irruptedly occurred unexpected changes of some physical parameters or some changes falling outside of predefined safe ranges of the container, and unexpected apart from the pre-designed route etc. The electronic device of the container generates status messages and sends out alarm responsive to a detection of signals for the security status for all above-mentioned types of changes of the physical parameters through the sensors. For example, the pre-designed route information is possibly renewed by an authorized subscriber through a terminal, such that the originally defined route contained in the basic information is changed. Whilst the electronic device may generates a corresponding status message responsive to the situation when the GPS positioning device in connection with the electronic devices detect that the container travels in deviation from the pre-designed route, for example, the container are berthed at a trans-shipment port other than a previously designated one or the container deviated far from the pre-designed route out of a permitted tolerant range, consequently the security status will be changed successive to the changes of the status of the container. In another example, when the container moves in such a delay that exceeds a predefined permitted time range, a status message will be generated by the electronic device, and a security status will be changed as well. Advantageously and preferably, the predefined criteria's and rules for determining the security status can be modified even in the monitoring, e.g. an estimated time of arrival can be reconfigured once the real traveling is delayed for some reasons.

Moreover, according to another embodiment of the present invention, the security status can be ranked form a lowest to a highest level and represented in different forms corresponding to the ranks, or even handled in different ways corresponding to different ranks of the security status according to predefined rules. For example, for a security status information with a higher rank, the management center handles it by determine a corresponding earlier warning or alert, which will be shown as a kind of indication information through a relevant user interface of the system of the management center, and/or initiatively forwarded to a designated terminal of an authorized subscriber, the relevant entity/owner of the cargo, shipping company, or other authorities through the Internet or mobile communication network by ways, such as pop-out messages, e-mail or other cell phone multi-media messages etc., including but not limited to sound alerts, text messages or possible graphic messages.

According to another embodiment of the invention, the management center may includes application severs which are specially function for performing statistic and analysis on the basis of comprehensive analysis of the basic information, the currently received status message and event information etc., thereby output analyzed statistic report and forecast report, which are retrievable by and/or sent to any authorized subscribers only, including the owner, the shipping company or other entities of interests. For example, these information may include a completed part of the journey and its cost time, a next station to be arrived at and its estimated time of arrival, wherein both completed and incomplete parts of the journey can be displayed and presented in the image or data.

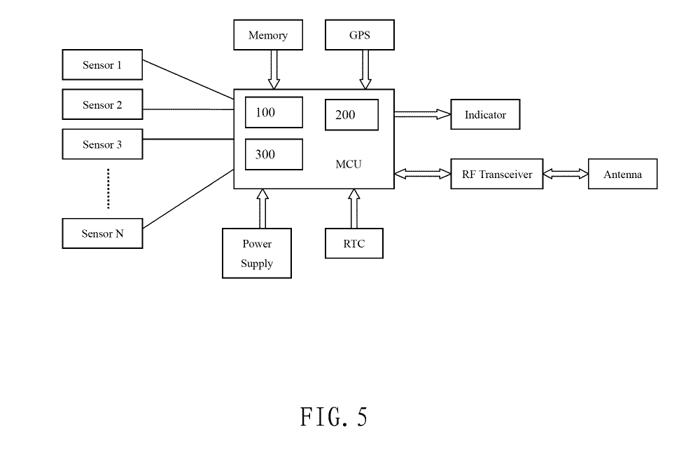

FIG. 5 shows a structural diagram of one embodiment of the electronic device in accordance with the present invention. The electronic device comprises a main control unit (MCU), various types of sensors with different functions, a memory for storing application programs and data, a radio frequency transceiver and an antenna, and a power supply device. According to one preferred embodiment of the invention, the electronic device is also provided with indication means, such as LED or LCD or speaker. Preferably, the electronic device may further connect an internally embedded GPS module or separate GPS module for receiving or sending GPS signal from satellites.

The main control unit of the electronic device includes a status message generator 100, which is configured to generate corresponding status messages responsive to various signals detected by the sensors, such as the component changes of the containers detected by the mechanical sensors, the temperature changes detected by the thermometer, the humidity changes detected by the humidity sensor, vibration or shock detected by the vibration or shock sensor, the dangerous gas leakage detected by the chemical sensor etc. Said status message is generated by comparing a detected status of the container with criteria predefined in the basic information according to business rules. Additionally, the status message generator can also be configured to generate the status messages related to the geological location according to the geological location information detected by the devices for determining the geological location, for example, a status message of deviating from the predefined route once the container travel apart from the predefined route out of a permitted range.

Furthermore, the main control unit of the electronic device also includes an information management module 200 and an event information processing module 300. The information management module 200 is used to configure or reconfigure criteria and/or logic rules for generation of the status message. The status message generator 100 generates status messages according to the logic rules configured/reconfigured by the information management module 200. Preferably, the status message can be ranked based on the rules, and presented on the indication means of the electronic device or the displays of the terminals in different colors, sounds, images, marks and/or attractability. The information management module 200 is optionally configured to activate the electronic device and immediately transmit the status message in line with the rank of the status message. The event information processing module 300 is used to handle all kinds of events and edit the event log. For example, these events may includes information for an inspection at one checkpoint of the port, e.g. an entrance of the port, the time when an objective container passing through a station or a passage, items and contents being examined, and the inspector responsible for that inspection etc., and additionally, may includes information for custom inspection, inspection and quarantine of the board, and/or import or export trade inspection, etc. Besides, information for each new initialization of the electronic device including the initializing time, the terminating time, the security status records and the number of the shipping etc. may also be handled and stored in the electronic device.

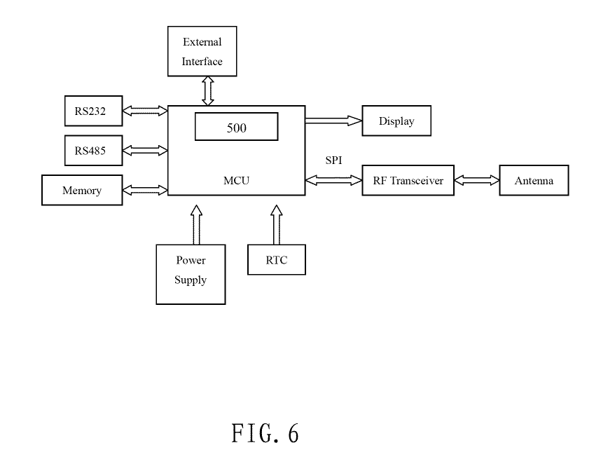

FIG. 6 shows one embodiment of the reader according to the present invention. The reader comprises a main control unit (MCU), a memory, a radio frequency transceiver and antenna, interface (RS232, RS485) in connection with terminals, external interfaces in connection with peripherals, a display and a power supply device etc., Said main control unit of the reader in accordance with one preferred embodiment of the invention further includes a communication control module 500, which is configured to process the status message received from the electronic device and upload the processed status message to the management center immediately through the associated terminal responsive to said status message; and also configured to forward an instruction for modifying the basic information of a container issued by an authorized subscriber of this network system to the electronic device of a designated container.

Although the invention has been described in terms of exemplary embodiments, it is not limited thereto. Rather, the appended claims should be construed broadly, to include other variants and embodiments of the invention, which may be made by those skilled in the art without departing from the scope and range of equivalents of the invention.

What is claim is:

1. A method for tracking and monitoring containers in a global supply chain based on a network system, which comprises a management center consisting of at least one server, multiple terminals accessible into said network through the Internet, and multiple readers respectively in communication with relevant associated terminals, said method comprising steps of:
providing a container to be monitored with an electronic device configured with a unique identifier number;
inputting basic information of said container to be monitored into said electronic device and performing encryption through a reader at a departure point;
detecting automatically the status of said container by said electronic device during the transportation, to generate a status message responsive to the detected status and record into said electronic device in real time;
recording events information into said electronic device by readers of any inspection stations when said electronic device passing through the inspection stations;
decrypting and extracting information of said electronic device by a reader at a destination point; characterized in that
uploading immediately any newly generated status message and recorded event information of said electronic device in real time to the management center through relevant associated readers and terminals in the whole monitoring process; and
retrieving and modifying information for a container in real time by a subscriber authorized to access said network system through a terminal.

2. The method as claimed in claim 1, wherein said basic information includes container information, cargo information, logistics information, and/or initialized security information.

3. The method as claimed in claim 2, wherein said cargo information includes bill number, name and type of cargo, weight of cargo, hazardous rank of cargo, number of sub-packages, and/or sub-volume.

4. The method as claimed in claim 2, wherein said container information includes information required by standardized IMC, IBC or RTC transportation.

5. The method as claimed in claim 2, wherein said logistics information includes information for vehicles including container trucks, unit trains, carrier and/or airplane, operation information, information of import/export or trans-shipment ports, and/or information of agencies.

6. The method as claimed in claim 2, wherein said initialized security information includes locking position, time, location, and/or physical status for a container at the locking time.

7. The method as claimed in claim 1, wherein said status message is generated by comparing a status of a container detected by said electronic device with criteria contained in the basic information according to preset rules, said status message comprises status changes of components of the container, geographical information of current location of the container, and/or physical status of the container.

8. The method as claimed in claim 7, wherein said geographical information of location of the container is determined by GPS technology and represented in data or image through a display of a terminal.

9. The method as claimed in claim 8, wherein the means for performing GPS positioning is embedded in said electronic device or said reader.

10. The method as claimed in claim 1, wherein said event information includes information of inspection of the port, inspection of the custom, inspection and quarantine of the board, and/or inspection of the import or export trade.

11. The method as claimed in claim 1, wherein an authorized subscriber of said network system may retrieve latest information of a container through any one terminal at any time, said information includes container information, security information, cargo information, logistic information, real-time status message, authorized inspection information, and/or other analyzed or forecast information directed from the management center based on overall comprehensive information of the container.

12. The method as claimed in claim 1, wherein the management center initiatively transmit the received status message of the container to a designated terminal of a relevant subscriber.

13. The method as claimed in claim 1, wherein a back up electronic device is provided for a container to be monitored.

14. An electronic device for tracking and monitoring a container in a global supply chain based on a network system, wherein said network system comprises a management center consisting of at least one server, multiple terminals which are accessible into said network through the Internet, and multiple readers respectively in communication with relevant associated terminals, and each container to be monitored being provided with an electronic device, said electronic device comprising a main control unit, various sensors, a memory, radio frequency transceiver, and a power supply device, wherein said main control unit includes:
a status message generator, which is configured to immediately transmit a newly generated status message via the radio frequency transceiver, so as to allow uploading the current status of the electronic device onto the management center through the associated readers and terminals in real time; and
an information management module, which is configured to modify the basic information of the container according to instructions made by a subscriber authorized to access said network system.

15. A reader for tracking and managing a container in a global supply chain based on a network system, wherein said network system comprises a management center consisting of at least one server, multiple terminals which are accessible into said network through the Internet, and multiple readers respectively in communication with relevant associated terminals, and each container to be monitored being provided with an electronic device, said reader comprising a main control unit, a memory, a radio frequency transceiver, an interface in communication connection with the associated terminal, and a power supply device, wherein said main control unit includes:
a communication control module, which is configured to process a status message received from an electronic device and immediately upload the processed status message through the terminal onto the management center; and send instructions for modifying the basic information of a designated container made by a subscriber authorized to access said network system to a corresponding electronic device of said container.
